(19) United States
(12) Patent Application Publication
(10) Pub. No.: US 2003/0210441 A1
(43) Pub. Date: Nov. 13, 2003

(54) Finely adjustable optical mechanism

(76) Inventors: Tzu-Hsiung Lee, Taipei (TW); Devon Shyu, Tainan Hsien (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/280,290

(22) Filed: Oct. 28, 2002

(30) Foreign Application Priority Data
May 10, 2002 (TW) 091206657

(51) Int. Cl. H04N 1/46

(52) U.S. Cl. 358/528; 358/528; 358/532

(57) ABSTRACT

A finely adjustable optical mechanism includes a base, a lens seat mounted on the base, a mirror set mounted on the base. A lens and an image sensor are mounted on the lens seat. A link is provided between the lens seat and the base. It is possible to move the lens seat relative to the base by rotating the link to move the lens seat or the base. Accordingly, the relatively positional relationship between the lens seat and the base can be finely adjusted.

### FIELD OF THE INVENTION

The present invention relates to an adjustable optical mechanism of a scanner, and more particularly, to an optical mechanism wherein the relative position between the lens and the reflection mirror set can be finely adjusted.

### BACKGROUND OF THE INVENTION

A conventional optical mechanism generally includes a lens, an image sensor such as CCD and a reflection mirror set composed of several reflection mirrors. The lens and the image sensor are mounted to a lens seat which is connected to a base together with a reflection mirror set.

It is to be noted that the lens is fixed to the base and the lens seat is fixed to the base by at least two pins or screws fixed on the base. Therefore, no relative movement is happened between the combination of the lens and the image sensor, and the reflection mirror set.

Because the lens seat and the reflection mirror set are fixed to the base, the focus and the depth of the scanned image may involve errors if the installation is not correct and precise. Although an adjusting method can be done to adjust the position of the lens seat and the reflection mirror set, it is difficult because both of which are fixed and the result is not satisfied and a worse scanning result will be obtained.

Besides, there is only one allocation for the reflection mirror set and the lens seat on the base, it is impossible to change the position of the lens seat and the focus of the lens to achieve the purpose of changing the focus. Therefore, the molds cannot be used in common and this increases the manufacturing cost.

### SUMMARY OF THE INVENTION

The present invention provides a finely adjustable optical mechanism which can be adjusted along multiple axes (directions) so as to be assembled precisely and obtain high quality of scanning.

Another object of the present invention is to provide a finely adjustable optical mechanism wherein the relative position between the lens seat and base can be adjusted so that the focus of the lens can be changed to change the magnifying rate and resolution without changing the base and the optical mechanism. Therefore, the molds can be used in common.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the present invention.

FIG. 2 is a top view of the assembly of the present invention.

FIG. 3 shows the assembly of the present invention.

FIG. 4 shows one of the movements of the adjustment.

FIG. 5 shows another movement of the adjustment.

FIG. 6 illustrates the movement of the present invention.

### DETAILED DESCRIPTION OF THE PREFERRED EMBODIMENT

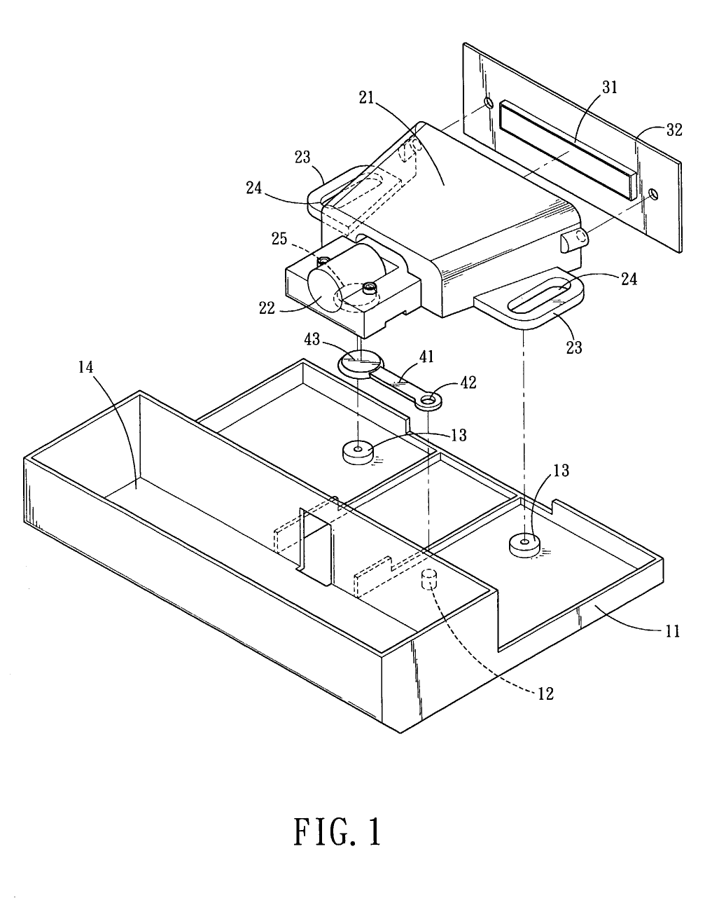

FIG. 1 is an exploded view of the present invention and discloses an optical mechanism which comprises a base 11, a lens seat 21, an image sensor 31 and a link 14.

The base 11 has a protrusion 12 on a surface thereof and two protruding locking posts 13. A chamber 14 is defined in an end of the base 11 and a reflection mirror set (not shown) composed of several reflection mirrors is received in the chamber 14.

A lens 22 is mounted on an end of the lens seat 21 which includes two lugs 23 on two sides. Each lug 23 has an elongate hole 24 and the lens seat 21 has a recess 25 in an underside of the lens seat 21.

The image sensor 31 in this embodiment is a CCD and fixed to a board 32. The link 41 is formed with a hole 42 at one end and a convex 43 at the other end.

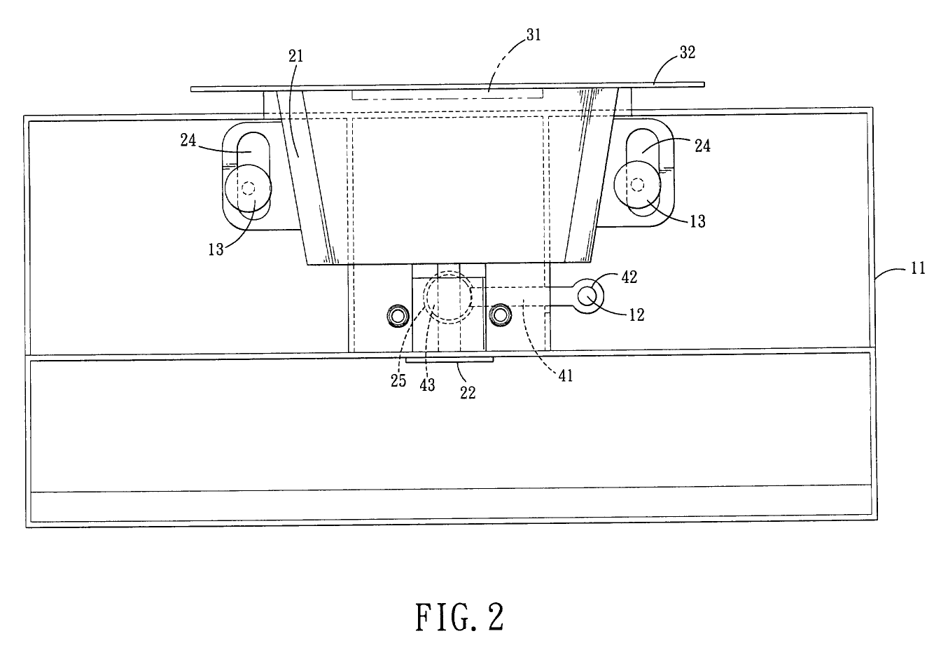

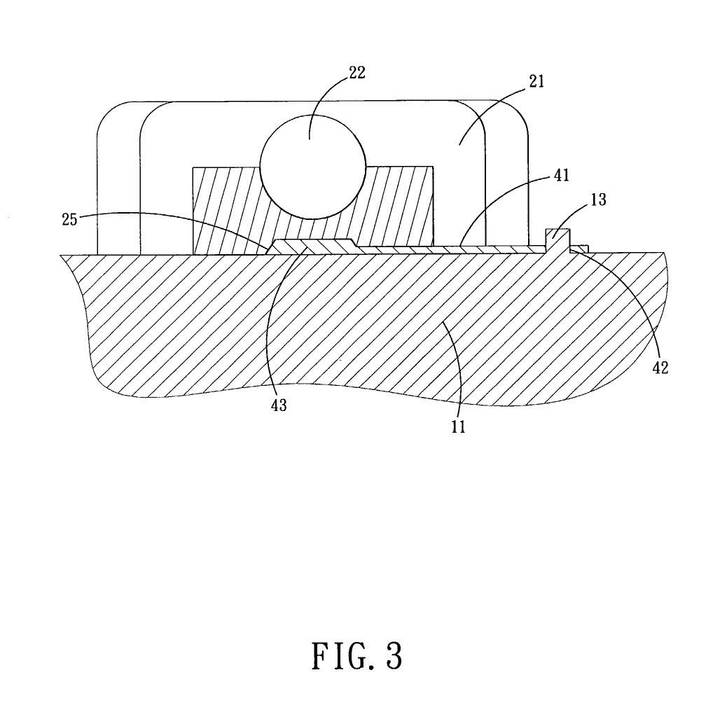

FIG. 2 is a top view of the assembly of the present invention and FIG. 3 shows the assembly of the present invention. The board 32 of the image sensor 31 is fixed to the end of the lens seat 21 and located away from and facing the lens 22. It is to be noted that the board 32 is movable and swingable relative to the lens seat 21, so that the relative position between the image sensor 31 and the lens 22 can be finely adjusted.

The lens seat 21 is connected to the base 11 and the two locking posts 13 of the base 21 are located in correspondence to the elongate holes 24 of the lens seat 21. A proper locking member (not shown) locks the locking posts 13 in the elongate holes 24.

The link 41 has the hole 42 at one end thereof to be mounted to the protrusion 12 and the link 41 is rotatable relative to the protrusion 12. The convex 43 of the link 41 is received in the recess 25 at the underside of the lens seat 21. The lens seat 21 can be swung by the engagement of the recess 25 and the convex 43.

In the practical manufacturing process, the lens seat 21 can be made of solid material so as to ensure that the image sensor 31 on the board 32 is perpendicular to the axis passing through the lens 22.

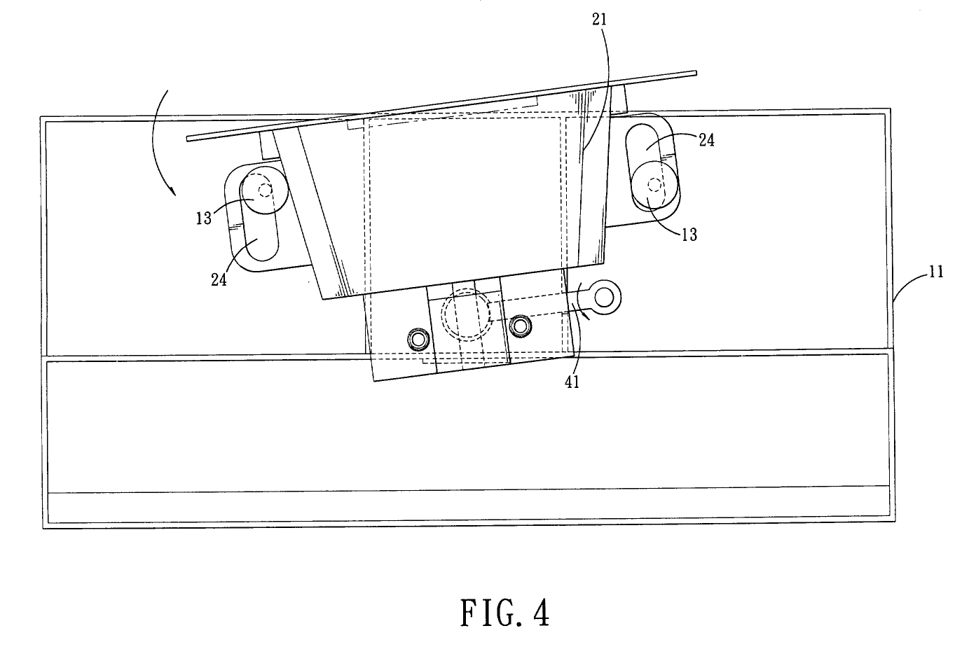

FIG. 4 shows one of the movements of the adjustment. The base 11 is fixed and the link 41 swings an angle from the horizontal position. By this way, the lens seat 21 moves downward and swings an angle. When the lens seat 21 swings, the elongate hole 24 is still maintained at the corresponding position.

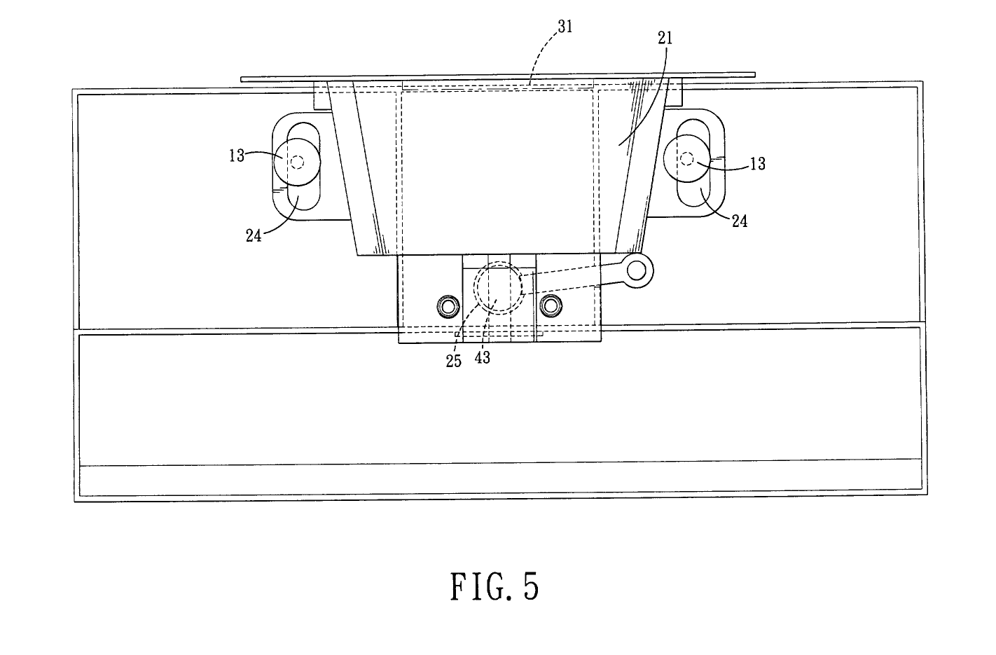

FIG. 5 shows another movement of the adjustment. After the lens seat 21 is swung, the lens seat 21 may rotate an angle due to the engagement of the convex 43 and the recess 25 so that the optical data of the image obtained from scanning may pass through the lens 22 and is received by the image sensor 31.

After the lens seat 21 is adjusted, the locking members are used to lock the locking posts 13 in the elongate holes 24 so that the lens seat 21 is fixed and not able to move and swing.

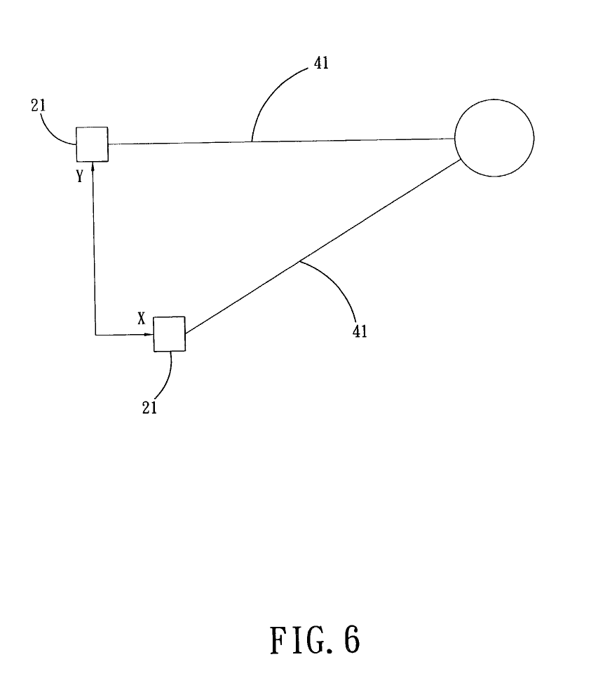

FIG. 6 illustrates the movement of the present invention. The blocks in the diagram represent the lens seats 21 and after the lens seat 21 and the link 41 swing and rotate, the positions in the X axis and the Y axis are both moved.

In other words, by the movements in the X axis and the Y axis, the lens seat 21 and the base 11 have relative movements in two directions. When further considering the self-rotation of the lens seat 21, the movement of the lens seat 21 can be adjusted in three directions. Correspondingly, the relative position between the lens 22 and the reflection mirror set (not shown) may be finely adjusted.

Thanks to the cooperation of the lens seat 21 and the link 41, the lens seat 21 on the base 11 can be adjusted in multiple directions. If the installation has any error, the relative position of the lens seat 21 and the base 11 may be finely adjusted. Accordingly, the scanned image information can pass through the reflection mirror set (not shown) on the base 11, the lens 22 on the lens seat 21, and can be received by the image sensor 31 to generate the best quality of the image.

The relative position of the lens seat 21 and the base 11 may be adjusted, the distance between the reflection mirror set (not shown) on the base 11 and the lens 22 on the lens seat 21 may be also adjusted. In the theory of forming of image, the distance between the reflection mirror set and the lens 22 means the change of the object distance. The unchanged distance between the lens 22 and the image sensor 31 represents the image distance is not changed. Accordingly, the manufacturers may only change the lens 22 of the optical mechanism to obtain the magnifying rate of the image and the resolution by the change of the relative positions of the lens 21 and the base 11. Therefore, the users may have different magnifying rates and resolutions without changing the size of the base 11 and the lens seat 21.

While we have shown and described the embodiment in accordance with the present invention, it should be clear to those skilled in the art that further embodiments may be made without departing from the scope of the present invention.

What is claimed is:

1. A finely adjustable optical mechanism comprising:
a base;
a lens seat mounted on the base;
a lens mounted on an end of the lens seat;
a board mounted on the lens seat and facing the lens;
an image sensor connected to the board; and
at least one link connected between the lens seat and the base so as to make the lens seat move relative to the base.

2. The finely adjustable optical mechanism as claimed in claim 1, wherein the link has two ends pivotably connected to the base and the lens seat, respectively.

3. The finely adjustable optical mechanism as claimed in claim 1, wherein the lens seat may be swung relative to the base so as to change its position.

4. The finely adjustable optical mechanism as claimed in claim 1, wherein the lens seat may be rotated relative to the base so as to change its inclination.
